(19) United States
(12) Patent Application Publication
(10) Pub. No.: US 2014/0168165 A1
(43) Pub. Date: Jun. 19, 2014

(54) ELECTRONIC DEVICE WITH VIRTUAL TOUCH FUNCTION AND INSTANT ADJUSTING METHOD FOR VIRTUAL TOUCH

(71) Applicant: ASUSTeK COMPUTER INC., TAIPEI (TW)

(72) Inventor: Fou-Ming LIOU, TAIPEI (TW)

(73) Assignee: ASUSTeK COMPUTER INC., TAIPEI (TW)

(21) Appl. No.: 14/102,513

(22) Filed: Dec. 11, 2013

(30) Foreign Application Priority Data
Dec. 13, 2012 (CN) 201210540146.6

(51) Int. Cl. G06F 3/042

(52) U.S. Cl. CPC G06F 3/0425
USPC 345/175

(57) ABSTRACT

An electronic device with virtual touch function and an instant adjusting method for virtual touch are provided. The instant adjusting method for virtual touch includes following steps: capturing an image of a user by an image capture device, sensing a distance between the image capture device and the user, defining a location and a size of a touch sensor region according to the distance, mapping the touch sensor region to an effective display region of the display screen, and displaying a display image mapped to the image on the display screen to allow the user to touch control a position of the display screen corresponding to a relative position of the touch sensor region according to the display image. The size of the image is constant regardless whether the distance changes or not.

### CROSS-REFERENCE TO RELATED APPLICATION

This application claims the priority benefit of CN application serial No. 201210540146.6, filed on Dec. 13, 2012. The entirety of the above-mentioned patent application is hereby incorporated by reference herein and made a part of specification.

### BACKGROUND OF THE INVENTION

1. Field of the Invention

The invention relates to a virtual touch method and, more particularly, to an electronic device with a virtual touch function and an instant adjusting method for virtual touch.

2. Description of the Related Art

In general, instead of conventional keys and cursor control devices, most users use a touch display for operating electronic devices, such as a PDA, a phone, a digital photo frame, or a digital panel. Compare with the physical input devices, inputting data via the touch display is more convenient.

As the touch displays becomes more popular, a new input technology to provide users to operate the electronic device instinctively is under development, which applies to home electronic appliance such as a TV or a computer. Without touching the electronic device directly or using a remote-controller, only by movements or gestures of the user, a command can be carried on.

Detaily, the electronic device can detect movements or gestures of the user corresponding to a specific instruction via a stereoscopic depth camera of the electronic device, therefore, the electronic device executes the corresponding instruction according to the movement. However, since only the absolute position of a cursor corresponding to a hand is displayed on a screen of the electronic device, if the user wants to trigger another position on the screen, the user needs to move the hand to the position to be triggered, consequently, the user usually feels that operation speed of the electronic device is low and the operation is not convenient.

### BRIEF SUMMARY OF THE INVENTION

An electronic device with a virtual touch function and an instant adjusting method for virtual touch are provided to execute instructions faster and improve the utilization rate, and they are more humanized.

An instant adjusting method for virtual touch is provided, it includes following steps: (a) capturing an image of a user by an image capture device; (b) sensing a distance between the image capture device and the user; (c) defining a location and a size of a touch sensor region according to the distance; (d) mapping the touch sensor region to an effective display region of a display screen; and (e) displaying an display image mapped to the image on the display screen to allow the user to touch control a position of the display screen corresponding to a relative position of the touch sensor region according to the display image, the size of the display image is constant regardless whether the distance changes or not. In one embodiment of the disclosure, the instant adjusting method for virtual touch further includes two following steps: determining whether the distance between the image capture device and the user is different from the previous distance before the step (c). If the distance is different from the previous distance, step (c) to step (e) are executed, and the size of the user image is adjusted to make the size of the display image displayed on the display unchanged in step (e).

In one embodiment of the disclosure, the step (C) further includes following steps: providing the size of the touch sensor region via default data in a comparison table according to the distance; calculating the size of the touch sensor region via a calculation formula according to the distance. In one embodiment of the disclosure, the step (d) further includes two following steps: mapping coordinate position of four corners of the touch sensor region to pixels of four corners of the effective display region of the display screen; proportionally adjusting all the coordinate positions of the touch sensor region and mapping all the coordinate positions of the touch sensor region to all the pixels of the effective display region so as to make that all the pixels of the effective display region are corresponding to all the coordinate positions of the touch sensor region.

In one embodiment of the disclosure, the step (e) further includes following, step: adjusting the image according to the distances and generating the display image displayed on the display screen.

in one embodiment of the disclosure, the step (e) further includes a step: fading, contouring, or perspective processing the display image before displaying the display image. In one embodiment of the disclosure, before the step (e), the instant adjusting method further includes a step: reading a specific program identification label. In the embodiment, the method further includes fading or perspective processing the display image before displaying the display image.

An electronic device with virtual touch function is provide, it includes an image capture device, a display screen and a computer host. The image capture device captures an image of at least a user and senses a distance between the user and the image capture device. The display screen is electrically connected with the image capture device and includes an effective display region. The computer host is electrically connected with the image capture device and the display screen, defining a location and a size of a touch sensor region according to the distances, displaying an display image mapped to the image on the display screen to allow a user to touch control as positron of the display screen corresponding to as relative position of the touch sensor region according to the display image, the size of the display image is constant regardless whether the distance changes or not.

In sum, the electronic device with virtual touch function and an instant adjusting method for virtual touch cooperates with an image of the user at the display screen, so that the user can interact intuitively with the electronic device, which is the same as that the user touches a tablet computer, instructions can be executed faster, the method is much more humanized, and the utilization rate is improved. Moreover, when the user has a motion which having a shaking front and back displacement, the electronic device with virtual touch function may remake the corresponding touch sensor region according to the changed distances between the user and the image capture device. Therefore, the system resource, the corresponding time and the cost of the electronic device are saved.

### BRIEF DESCRIPTION OF THE DRAWINGS

FIG. 1 is a block diagram showing an electronic device with a virtual touch function in an embodiment;

FIG. 2 is a front view showing a user keeps a first distance from the electronic device and operates the electronic device in an embodiment;

FIG. 3 is a flow chart of an instant adjusting method for virtual touch in an embodiment; and

FIG. 4 is a front view showing the user keeps a second distance from the electronic device and operates the electronic device in an embodiment.

### DETAILED DESCRIPTION OF THE EMBODIMENTS

In the embodiments of the disclosure, when a user faces a display screen, a touch sensor region between the user and the display screen is provided, and a display image which is the same as the motion of the user is displayed on the display screen to provide to the user as a reference position, then, when the user triggers the touch sensor region, an icon on the display screen corresponding to the touch sensor region is triggered. Therefore, compared with a conventional method that the icon is triggered by moving the cursor, a virtual touch method in embodiments is more humanized, instructions can be executed much faster and the utilization rate is improved.

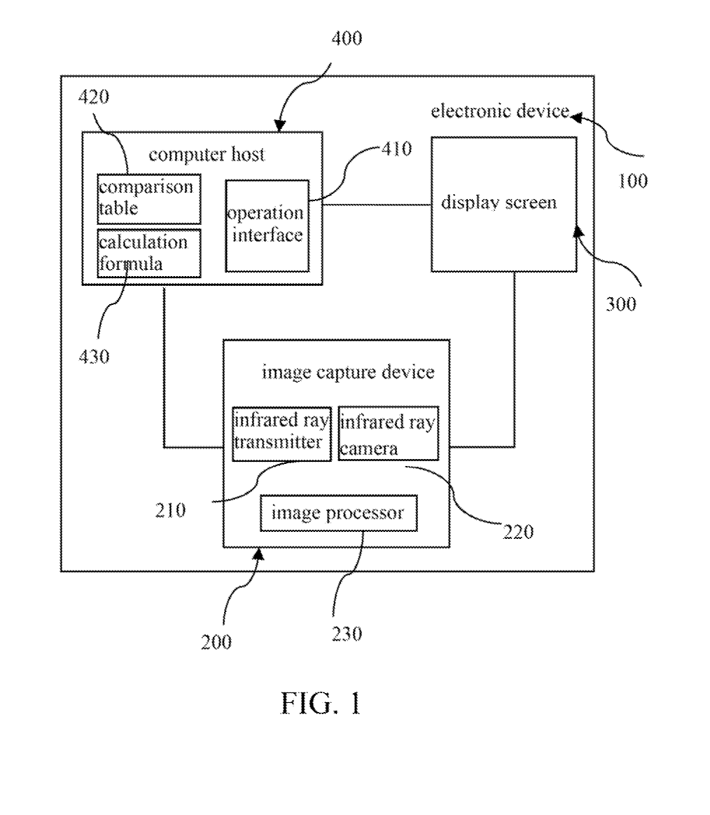

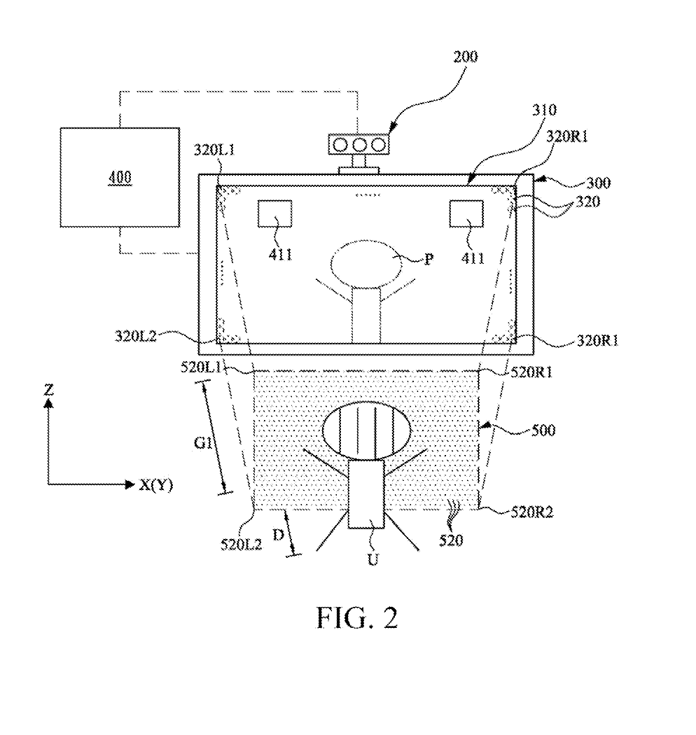

FIG. 1 is a block diagram showing an electronic device 100 with virtual touch function in an embodiment. FIG. 2 is a front view showing a user keeps a first distance G1 from the electronic device 100 and operates the electronic device 100 in an embodiment.

Please refer to FIG. 1 and FIG. 2. The electronic device 100 with a virtual touch function includes an image capture device 200, a display screen 300, and a computer host 400. The image capture device 200 (such as a 3D depth camera) is electrically connected with the computer host 400 and the display screen 300. the image capture device 200 is usually disposed together with the display screen 300. For example, the image capture device 200 is above the display screen 300 and it can continuously capture the image (such as a stereoscopic depth image or a flat image) of at least a user U, and senses the first distance G1 between the user and the image capture device 200 via the image. The computer host 400 can provides an operation interface 410 via the display screen 300, and the operation interface 410 includes at least one icon 411. The computer host 400 may be a desktop computer, a notebook computer, a tablet computer, a PDA, a smart phone, a translating machine, a game machine, or a GPS computer, which is not limited herein. The display screen 300, such as a display, is electrically connected with the image capture device 200 and the computer host 400, and it can display the operation interface 410 and the display image P generated by the above continuous image. An effective display region 310 of the display screen 300 includes multiple pixels 320 arranged in array. The computer host 400 forms a touch sensor region 500 according to the data transferred from the image capture device 200, the touch sensor region 500 is supposed to be between the display screen 300 and the user U. The touch sensor region 500 can be regarded as a plane formed by the Z axis and X(Y) axis, and it includes multiple coordinate positions arranged in array.

Therefore, when the user touches a relative position of the touch sensor region 500 to trigger the icon 411 on the operation interface 410, the computer host 400 operates correspondingly.

In one embodiment of the disclosure, the image capture device 200 includes an infrared ray transmitter 210, an infrared ray camera 220, or an image processor 230. The image capture device 200 encodes the depth space via continuous light coding technology to provide a stereoscopic depth image of the user, which is not limited herein. In the continuous light coding technology, firstly, the infrared ray transmitter 210 transmits an infrared ray to a user space to encode in the user space. For example, different shape speckles are generated and they represent the depth coding data at different areas of the user space. Then, the infrared ray camera 220 senses the infrared ray (that are speckles) in the user space to provide a plurality of the depth coding data of the user spaces. Afterwards, the image processor 230 receives the depth coding data and decodes the depth coding data to generate a user image (such as the stereoscopic depth image).

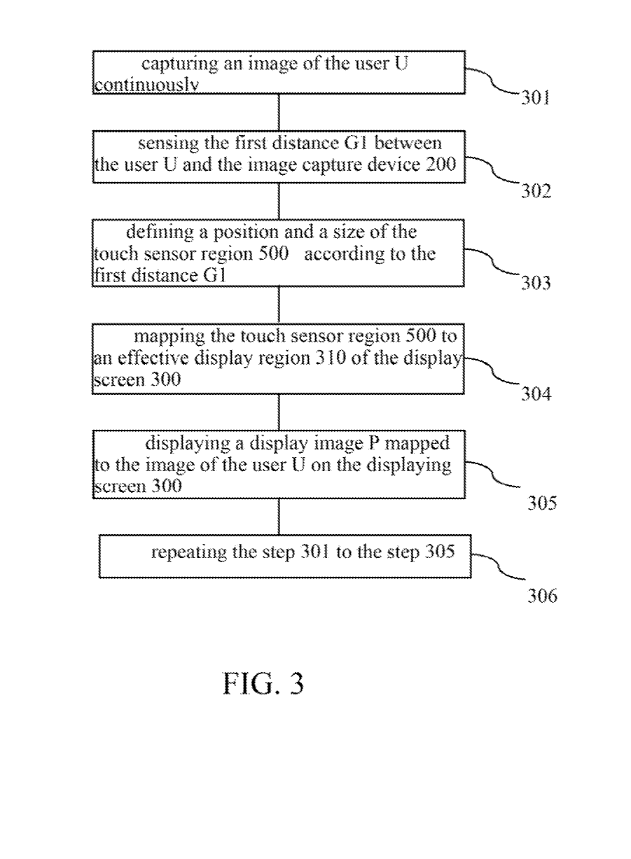

FIG. 3 is a flow chart of an instant adjusting method for virtual touch in an embodiment. Please refer to FIG. 3. The instant adjusting method for virtual touch in the embodiment includes the following steps.

In the step 301, capturing an image of the user U continuously. In the step 302: sensing the first distance G1 between the user U and the image capture device 200. In the step 303: defining a position and a size of the touch sensor region 500 according to the first distance G1. In the step 304: mapping the touch sensor region 500 to an effective display region 310 of the display screen 300. In the step 305: displaying a display image P mapped to the image of the user U on the displaying screen 300. In the step 306: repeating the step 301 to the step 305.

Therefore, the position of the display image P or the position of a part of the display image P (such as a hand or a foot, and/or a head) displayed on the display screen 300 can be used as a reference position, and when the user touches at the space of the touch sensor region 500, the same effect will be generated just like that the user triggers the icon 411 on the display screen 300 corresponding to the touch sensor region 500.

Please refer to FIG. 1 and FIG. 2. In step 301, the image capture device 200 continuously captures multiple images from the user U, such as, 30 frames per second.

Please refer to FIG. 1 and FIG. 2. In step 302, the image capture device 200 senses the first distance G1 between every point of the image and the image capture device 200 according to the captured image.

Moreover, in an embodiment, in step 301 or step 302, the image capture device 200 gets the proportion size of the user U according to the captured image of the user U and the first distance G1. The proportion size of the user U may be the proportion of a body and a hand, the proportion of a body and limbs, or the proportion of a hand and limbs.

Please refer to FIG. 1 and FIG. 2. In an embodiment, the step 303 further includes: providing the size of the touch sensor region 500 via default data of a comparison table 420 in the computer host 400 according to the first distance G1.

For example, kinds of distances are pre-stored in the comparison table 420, and each of the distances is corresponding to the touch sensor region 500 with a matched size, which is not limited herein. The comparison table 420 can provide the touch sensor region 500 with different sizes along with different distances. When the distance is the same, the comparison table 420 only provides the touch sensor region 500 with a constant size regardless of the size of the user.

In another example, the touch sensor region 500 corresponding to different distances and different body proportions are pre-stored in the comparison table 420, which is not limited herein. Therefore, when the computer host 400 senses the first distance G1 by the image capture device 200 and gets the proportion size of the user according to the image, the computer host 400 provides the corresponding size of the touch sensor region 500 according to the default data of the comparison table 420.

In an embodiment, the step 302 further includes: calculating the range of the touch sensor region via a calculation formula 430 in the computer host 400 according to the first distance G1.

For example, according to the calculation formula 430 and other parameters, such as the proportion size of the body of the user U, the touch sensor region 500 of different sizes can be get, which is not limited herein. Consequently, when the computer host 400 senses the first distance G1 by the image capture device 200 and gets the proportion size of the user via the image, the computer host 400 can calculate the size of the corresponding touch sensor region 500.

The above method of getting the size of the touch sensor region 500 is just taken as an example, which is not limited herein.

Moreover, in the step, the space of the touch sensor region 500 is defined at a position according to a preset distance D, for example, the distance is 30 cm to 50 cm away from the user. The touch sensor region 500 is supposed to set between the user U and the display screen 300. The display screen 300 can be regarded as a plane formed by the Z axis and X(Y) axis and including multiple coordinate positions arranged in array.

Please refer to FIG. 1 and FIG. 2. In an embodiment of the disclosure, in step 304, for example, the shape of the touch sensor region 500 is a rectangle, and the effective display region 310 of the display screen 300 has a rectangle shape.

In the embodiment, the computer host 400 first gets four corner coordinates 520 at the touch sensor region 500 and four corner pixels 320 at the effective display region 310. For example, the four corner coordinates of the touch sensor region 500 are four corner coordinates 520R1, 520R2, 520L1 and 520L2 respectively at a top right corner, a bottom right corner, a top left corner, and a bottom left corner, and the four corner pixels 320 of the effective display region 310 are four corner pixels 320R1, 320R2, 320L1, and 320L2 respectively at a top right corner, a bottom right corner, a top left corner, and a bottom left corner in FIG. 2. Then the computer host 400 draws a mapping range by making the four corner coordinates 520 of the touch sensor region 500 corresponding to the four corner pixels 320 of the effective display region 310. Then, the computer host 400 makes all the coordinates 520 of the touch sensor region 500 be proportionally corresponding to all pixels 320 of the effective display region 310 to make all pixels 320 of the effective display region 310 be proportionally corresponding to all the coordinates 520 of the touch sensor region 500.

Please refer to FIG. 1 and FIG, 2, in one embodiment of the disclosure, in step 305, a display image P is generated on the display screen 300 according to the first distance G1 between the image capture device 200 and the user U. Furthermore, the image size of the user U continuously captured by the image capture device 200 is adjusted (zoomed in or out) to make the size of the display image P displayed on the display screen 300 constant according to the change of the first distance G1 between the image capture device 200 and the user U.

In an embodiment, in step 305, the image size of the user can be adjusted according to the first distance G1 between the image capture device 200 and other parameters to generate the display image P displayed on the display screen 300, the parameter may be but not limited to the proportion size of the user U.

The method of adjusting the image is just an example, which is not limited herein.

In an embodiment, in step 305 the computer host 400 can have a fading, a contour process, or a perspective process on the display image P to make the user see the display content on the display screen 300 more clearly.

In an embodiment of the disclosure, in step 305, when the computer host 400 executes a game program, the computer host 400 provides the display image P on the display screen 300 when it reads a specific program identification label. Otherwise, if the computer host 400 does not read the specific program identification label, the computer host 400 does not provide the display image P on the display screen 300 to avoid the overlapping between the default first-person image in the game program and the display image P of the user U.

In another embodiment, after the computer host 400 reads the specific program identification label, the display image P of the user U is faded, contoured, or perspective processed, and thus the overlapping between the default first-person image in the game program and the display image P of the user U can be reduced when the display image P is generated on the display screen 300.

Moreover, the display image P is not limited to be the image captured by the capture device 200, it also may be produced according to data in a database (such as a panda shape) and the size of the user to provide a synchronized non-humanoid image corresponding to the motion of the user.

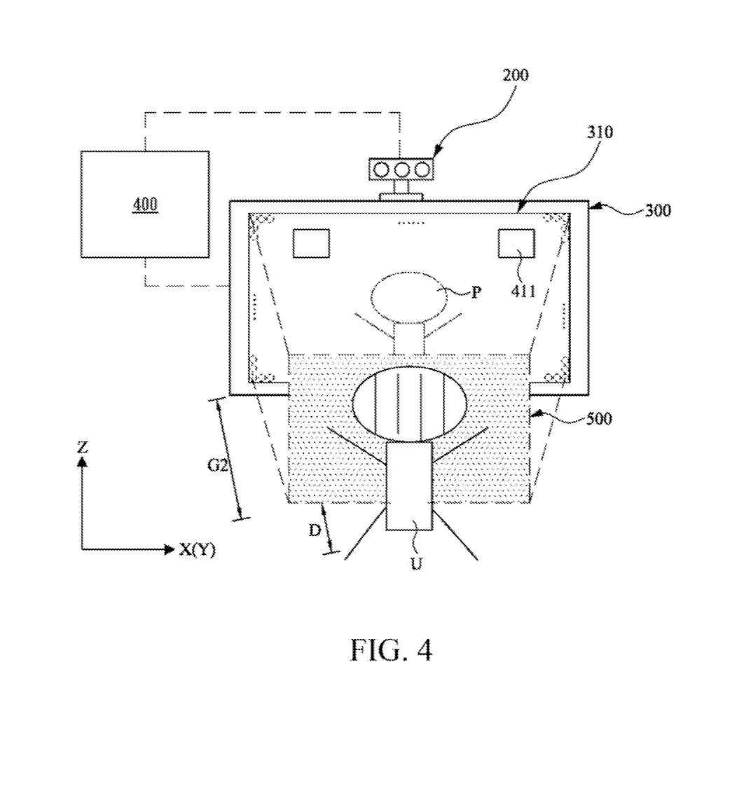

FIG. 4 is a front view showing the user keeps a second distance from the electronic device and operates the electronic device in an embodiment.

Please refer to FIG. 3. In one embodiment of the disclosure, in the step 306, when repeating the step 302 to the step 303, before the step 303, the method further includes determining whether the current distance is different from the previous distance. If Yes, the step 303 to the step 306 are executed, and the image size of the user U is adjusted to make the display image P on the display screen 300 have a constant size in the step 305.

As shown in FIG. 4, when the user U approaches the display screen 300, and the distance is reduced from the first distance G1 to the second distance G2, the image of the user U captured at this time point is reduced correspondingly according to the change between the first distance G1 and the distance G2 to make the size of the display image P on the display screen 300 unchanged. Otherwise, If there is no difference between the current distance and previous distance, the method turns to the step 305 and the image is processed according to the original data

Although the present disclosure has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An instant adjusting method for virtual touch, the method comprising following steps:
(a) capturing an image of a user by an image capture device;
(b) sensing a distance between the image capture device and the user;
(c) defining a location and a size of a touch sensor region according to the distance;
(d) mapping the touch sensor region to an effective display region of a display screen; and
(e) displaying a display image mapped to the image on the display screen for the user to touch control a position of the display screen corresponding to a relative position of the touch sensor region according to the display image, wherein the size of the displaying image is constant regardless whether the distance changes or not.

2. The instant adjusting method for virtual touch according to claim 1, further comprising:
determining whether the distance between the image capture device and the user is different from the previous distance before the step (c); wherein if the distance is different from the previous distance, step (c) to step (e) are executed, and the size of the image is adjusted to make the size of the display image displayed on the display screen unchanged in step (e).

3. The instant adjusting method for virtual touch according to claim 1, wherein the step (c) further comprises:
providing the size of the touch sensor region via default data in a comparison table according to the distance.

4. The instant adjusting method for virtual touch according to claim 1, wherein the step (c) further comprises:
calculating the size of the touch sensor region via a calculation formula according to the distance.

5. The instant adjusting method for virtual touch according to claim 1, wherein the step (d) further comprises:
mapping, coordinate position of four corners of the touch sensor region to pixels of four corners of the effective display region of the display screen; and
proportionally adjusting all the coordinate positions of the touch sensor region and mapping all the coordinate positions of the touch sensor region to all the pixels of the effective display region.

6. The instant adjusting method for virtual touch according to claim 1, wherein the step (e) further comprises:
adjusting the image according to the distance and generating the display image displayed on the display screen.

7. The instant adjusting method for virtual touch according to claim 1, wherein the step (e) further comprises:
fading, contouring, or perspective processing the display image before displaying the display image.

8. The instant adjusting method for virtual touch according to claim 1, wherein before the step (e), the instant adjusting, method further comprises:
reading a specific program identification label.

9. The instant adjusting method for virtual touch according to claim 8, wherein the step (e) further comprises:
fading, contouring, or perspective processing the display image before displaying the display image.

10. An electronic device with virtual touch function, comprising:
an image capture device used to capture an image of a user and sense a distance between the image capture device and the user;
a display screen electrically connected with the image capture device and including an effective display region; and
a computer host electronically connected with the image capture device and the display screen, used to define a location and a size of an touch sensor region according to the distance, map the touch sensor region to an effective display region of a display screen, and display an display image mapped to the image on the display screen to allow a user to touch control a position of the display screen corresponding to a relative position of the touch sensing region according to the display image, wherein the size of the displaying image is constant regardless whether the distance changes or not.
